(19) United States
(12) Patent Application Publication
(10) Pub. No.: US 2023/0342639 A1
(43) Pub. Date: Oct. 26, 2023

(54) SYSTEM AND METHOD FOR REDUCTION OF DATA TRANSMISSION BY DATA STATISTIC VALIDATION

(71) Applicant: Dell Products L.P., Round Rock, TX (US)

(72) Inventors: Ofir Ezrielev, Be'er Sheva (IL); Jehuda Shemer, Kfar Saba (IL)

(21) Appl. No.: 17/726,308

(22) Filed: Apr. 21, 2022

(51) Int. Cl. G06N 5/04; G06F 16/23

(52) U.S. Cl. CPC G06N 5/04; G06F 16/2365

(57) ABSTRACT

Methods and systems for managing data collection are disclosed. To manage data collection, a system may include a data aggregator. The data aggregator may utilize inference models to predict the future operation of data collectors. To validate these inferences, the data aggregator may compare a data statistic (a reduced-size representation of a series of measurements) to a complementary data statistic based on a set of inferences. If the complementary data statistic is determined accurate, the data aggregator may store the inferences as validated data and operate as though it has access to the measurements from the data collector. By doing so, the system may be able to transmit less data, consume less network bandwidth, and consume less energy throughout a distributed system.

### FIELD

Embodiments disclosed herein relate generally to data collection. More particularly, embodiments disclosed herein relate to systems and methods to limit the transmission of data over a communication system during data collection.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a block diagram illustrating a data aggregator in accordance with an embodiment.

FIG. 2B shows a block diagram illustrating a data collector in accordance with an embodiment.

FIGS. 3A-3B show a flow diagram illustrating a method of validating inferences generated by an inference model in accordance with an embodiment.

FIG. 3C shows a flow diagram illustrating a method of data collection in accordance with an embodiment.

FIG. 3D shows a flow diagram illustrating a method of data management in accordance with an embodiment.

FIGS. 4A-4F show block diagrams illustrating a system in accordance with an embodiment over time.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for managing data collection in a distributed system. To manage data collection, the system may include a data aggregator. The data aggregator may utilize inference models to predict future measurements from data collectors throughout a distributed system without having access to the measurements.

To obtain the inference models, training data may be used to train the inference models to predict future measurements obtained by the data collectors. The data collectors may include any type and quantity of data collectors including, for example, temperature data collectors, pH data collectors, humidity data collectors, etc. Therefore, the disclosed system may be broadly applicable to a wide variety of data collectors that may generate various types and quantities of measurements.

To attempt to reduce data transmission, the data aggregator may obtain a data statistic from a data collector, a data statistic being any reduced-size representation of a series of measurements. The data aggregator may obtain a complementary data statistic based on a set of inferences from an inference model. The data aggregator may compare the data statistic obtained from the data collectors to the complementary data statistic obtained from a series of inferences to determine accuracy of the inference model. If the complementary data statistic matches the data statistic within some threshold, the inferences may be determined accurate. If the complementary data statistic does not match the data statistic within some threshold, the inferences may be determined inaccurate.

If the inferences are determined accurate, the data aggregator may store the inferences as validated data and may not obtain the actual data from the corresponding data collectors. If the inferences are determined inaccurate, the data aggregator may take corrective action to increase the accuracy of future inferences and collect the actual data from the corresponding data collectors. By doing so, the data aggregator may operate as though it has access to measurements from data collectors without directly obtaining the measurements.

By implementing a threshold for accuracy of the inferences, the data aggregator may control the amount of information transmitted over communication system 101. In a first scenario, implementing a higher threshold may allow less accurate inferences to be validated by the data aggregator and, therefore, less information may be transmitted during data collection throughout a distributed system. In a second scenario, implementing a lower threshold may prevent less accurate inferences from being validated by the data aggregator and, therefore, more information may be transmitted during data collection in order to increase accuracy of the validated data.

In an embodiment, a method for managing data collection is provided. The method may include obtaining, from a data collector, a data statistic, the data statistic being based on a series of measurements performed by the data collector; making a determination that the data statistic does not match a complementary data statistic obtained by a data aggregator that does not have access to the series of measurements when the complementary statistic is obtained, the complementary statistic being based on a series of inferences generated by the data aggregator; based on the determination: treating the series of inferences as being inaccurate; and obtaining at least a portion of the series of measurements from the data collector.

The method may also include obtaining, from a data collector, a second data statistic, the second data statistic being based on a second series of measurements performed by the data collector; making a second determination that the second data statistic matches a second complementary statistic obtained by the data aggregator that does not have access to the second series of measurements when the second complementary statistic is obtained, the second complementary statistic being based on a second series of inferences generated by the data aggregator; based on the second determination: treating the second series of inferences as being accurate; and allowing the data collector to discard the second series of measurements without providing the data aggregator with the second series of measurements.

The method may also include based on the determination: updating an inference model that was used to obtain the series of inferences generated by the data aggregator, the updating performed using a training data set comprising, at least in in part, a portion of the series of inferences generated by the data aggregator and the at least the portion of the series of measurements from the data collector.

The series of inferences may be generated by the data aggregator using an inference model trained using a training data set, the training data set comprising a second series of measurements performed by the data collector, the second series of measurements being performed prior to the series of measurements.

The data statistic may comprise one selected from a group consisting of an average of the series of measurements performed by the data collector, a mode of the series of measurements performed by the data collector, and a median of the series of measurements performed by the data collector.

The series of measurements may be obtained using a sensor that measures a characteristic of an ambient environment.

The series of inferences may be generated using an inference model trained to duplicate the series of measurements, the inference model being hosted by the data aggregator.

A non-transitory media may include instructions that when executed by a processor cause the computer-implemented method to be performed.

A data processing system may include the non-transitory media and a processor, and may perform the computer-implemented method when the computer instructions are executed by the process.

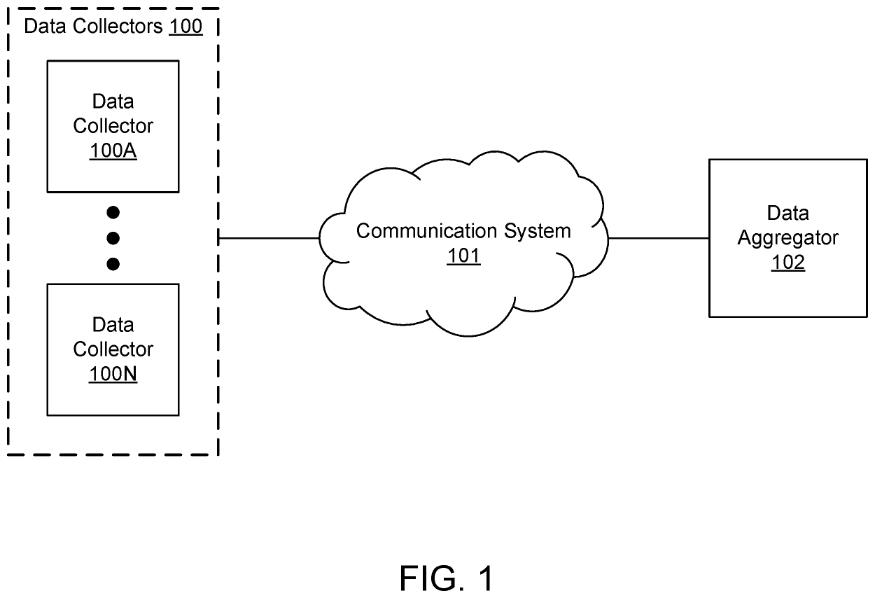

Turning to FIG. 1, a block diagram illustrating a system in accordance with an embodiment is shown. The system shown in FIG. 1 may provide computer-implemented services that may utilize data aggregated from various sources throughout a distributed system.

The system may include data aggregator 102. Data aggregator 102 may provide all, or a portion, of the computer-implemented services. For example, data aggregator 102 may provide computer-implemented services to users of data aggregator 102 and/or other computing devices operably connected to data aggregator 102. The computer-implemented services may include any type and quantity of services which may utilize, at least in part, data aggregated from a variety of sources (e.g., data collectors 100) within a distributed system.

For example, data aggregator 102 may be used as part of a control system in which data that may be obtained by data collectors 100 is used to make control decisions. Data such as temperatures, pressures, etc. may be collected by data collectors 100 and aggregated by data aggregator 102. Data aggregator 102 may make control decisions for systems using the aggregated data. In an industrial environment, for example, data aggregator 102 may decide when to open and/or close valves using the aggregated data. Data aggregator 102 may be utilized in other types of environments without departing from embodiments disclosed herein.

To facilitate data collection, the system may include one or more data collectors 100. Data collectors 100 may include any number of data collectors (e.g., 100A-100N). For example, data collectors 100 may include one data collector (e.g., 100A) or multiple data collectors (e.g., 100A-100N) that may independently and/or cooperatively provide data collection services.

For example, all, or a portion, of data collectors 100 may provide data collection services to users and/or other computing devices operably connected to data collectors 100. The data collection services may include any type and quantity of services including, for example, temperature data collection, pH data collection, humidity data collection, etc. Different systems may provide similar and/or different data collection services.

To aggregate data from data collectors 100, some portion and/or representations of data collected by data collectors 100 may be transmitted across communication system 101 to data aggregator 102 (and/or other devices). The transmission of large quantities of data over communication system 101 may have undesirable effects on the communication system 101, data aggregator 102, and/or data collectors 100. For example, transmitting data across communication system 101 may consume network bandwidth and increase the energy consumption of data collectors 100 used for data transmission.

In general, embodiments disclosed herein may provide methods, systems, and/or devices for managing data collection (e.g., also referred to as “data aggregation”) in a distributed system. To manage data collection in a distributed system, a system in accordance with an embodiment may limit the transmission of data between components of the system while ensuring that all components that need access to the data to provide their respective functions are likely to have access to accurate data (e.g., such as the data collected by data collectors 100). By limiting the transmission of data, communication bandwidth of the system of FIG. 1 may be preserved, energy consumption for data transmission may be reduced, etc.

To limit the transmission of data, data collectors 100 may transmit only a data statistic (or other reduced-size representation of a quantity of data) rather than the data itself unless explicitly instructed to do so by an aggregator.

To provide its functionality, data aggregator 102 may (i) obtain a data statistic from a data collector, (ii) obtain a complementary data statistic based on a series of inferences generated by the data aggregator, (iii) determine an accuracy of the series of inferences by comparing the data statistic from the data collector to the complementary data statistic, (iv) when the complementary data statistic is determined to be inaccurate, perform corrective action to improve the accuracy of future inferences obtained by the aggregator, and (v) when the complementary statistic is determined to be accurate, treat the series of inferences generated by the data aggregator as being measurements provided by the data collector. By doing so, data aggregator 102 may perform data aggregation without obtaining (all of, or a portion thereof) a series of measurements from data collectors 100 and, therefore, reduce data transmission.

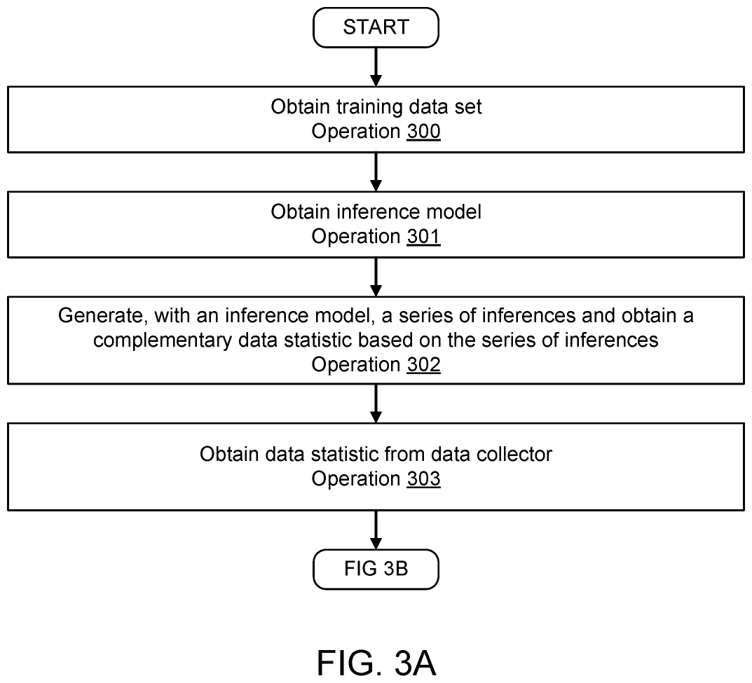

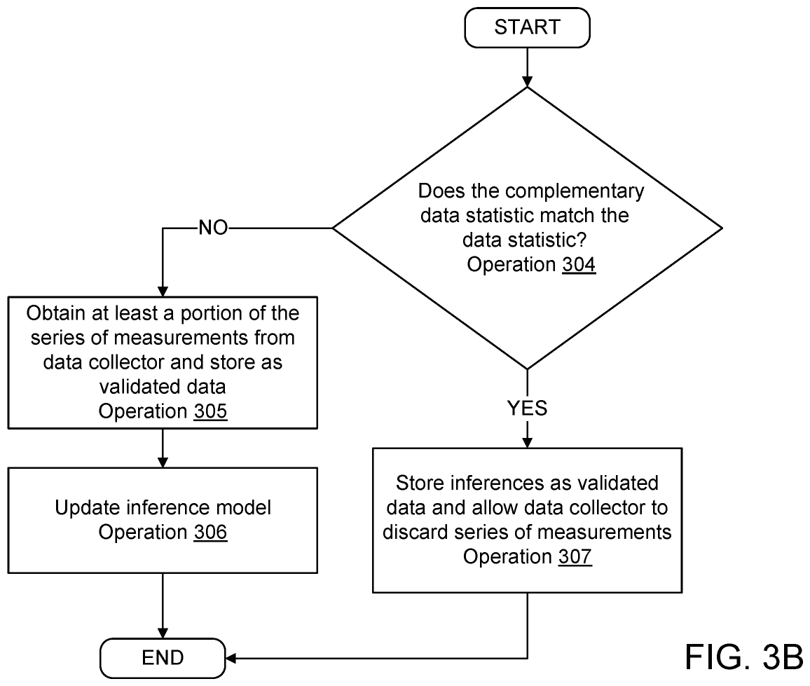

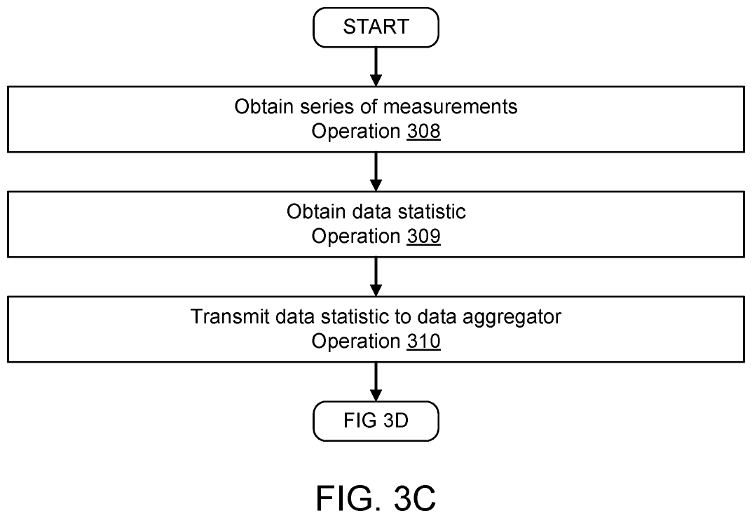

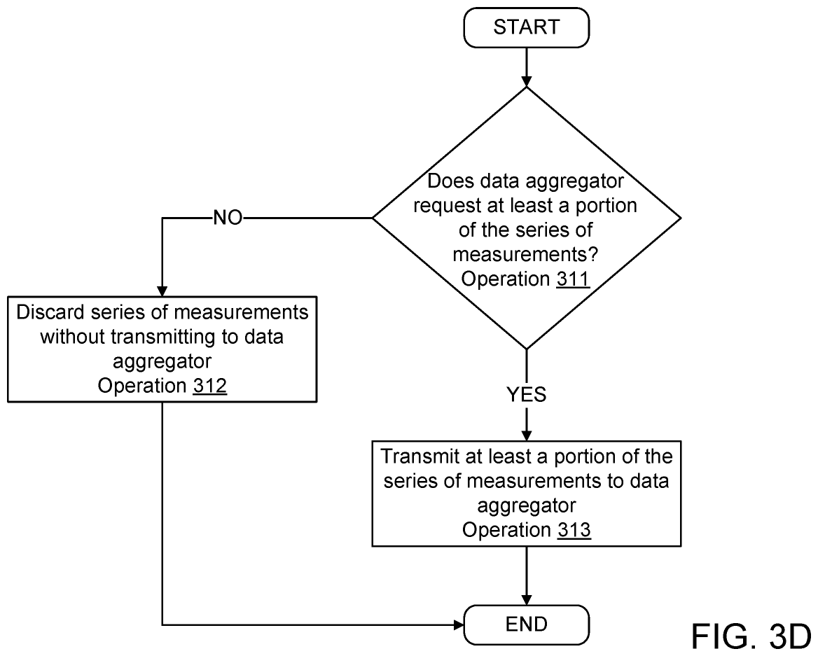

When performing its functionality, data aggregator 102 may perform all, or a portion, of the methods and/or actions shown in FIGS. 3A-3B.

To provide its functionality, data collectors 100 may (i) obtain measurements of interest to an aggregator or other entity, (ii) generate a data statistic or other reduced-size representation of the measurements, (iii) transmit the data statistic to data aggregator 102, and/or (iv) transmit at least a portion of the series of measurements when requested by the data aggregator 102, which may do so based on the data statistic. By doing so, data collectors 100 may transmit a reduced quantity of data to data aggregator 102 for aggregation purposes thereby decreasing the load on data collectors 100 for data aggregation purposes.

When performing its functionality, data collectors 100 may perform all, or a portion, of the methods and/or actions shown in FIGS. 3C-3D.

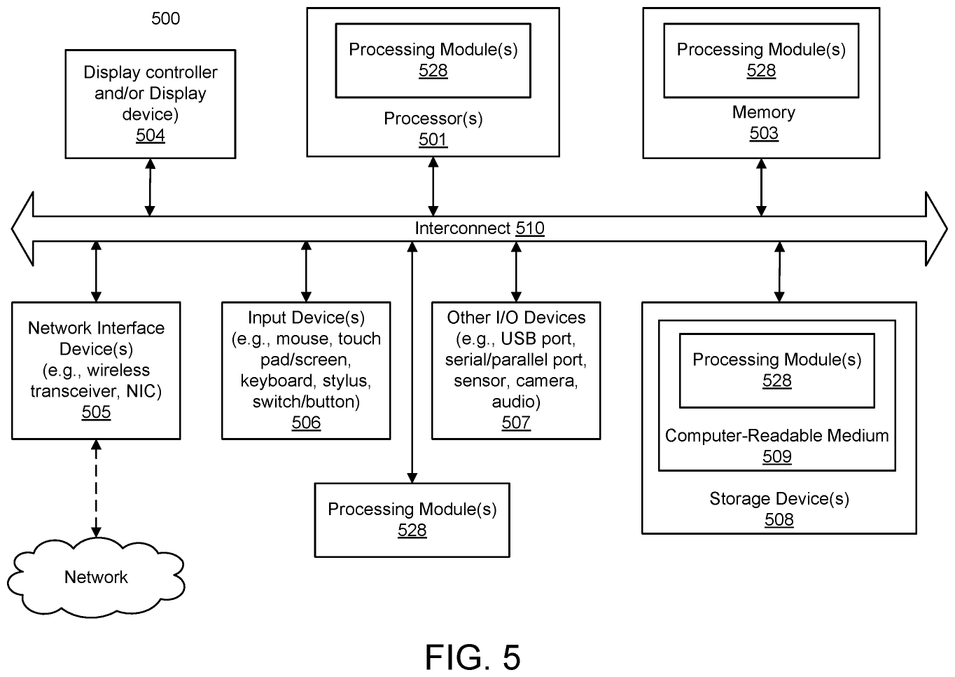

Data collectors 100 and/or data aggregator 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 5.

In an embodiment, one or more of data collectors 100 are implemented using an internet of things (IoT) device, which may include a computing device. The IoT device may operate in accordance with a communication model and/or management model known to the data aggregator 102, other data collectors, and/or other devices.

Any of the components illustrated in FIG. 1 may be operably connected to each other (and/or components not illustrated) with a communication system 101. In an embodiment, communication system 101 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as included a limited number of specific components, a system in accordance with an embodiment may include fewer, additional, and/or different components than those illustrated therein.

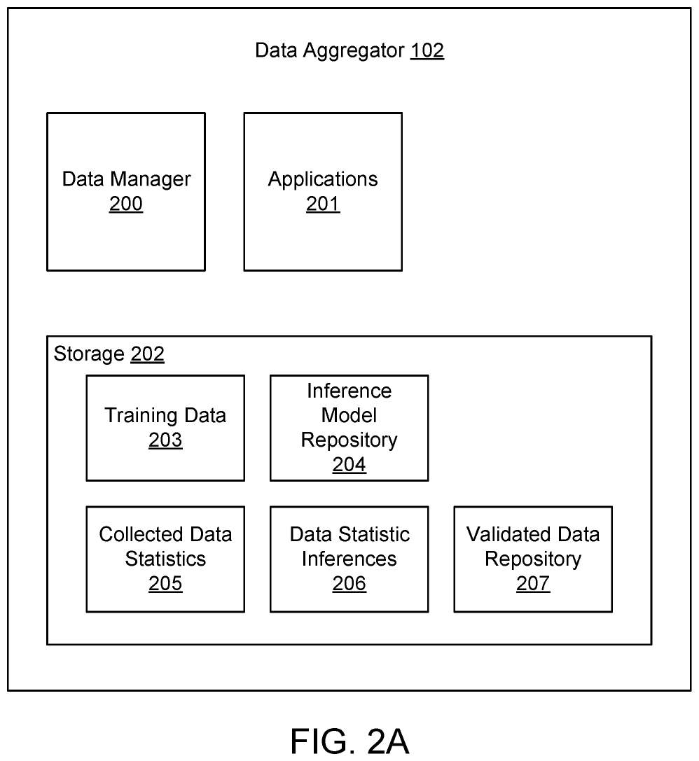

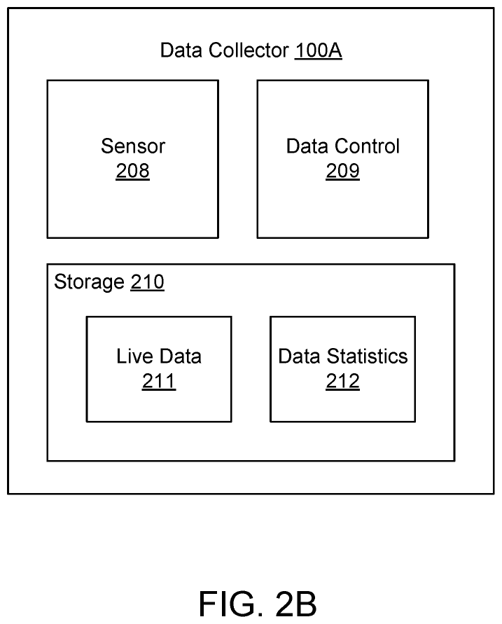

As discussed above, the system of FIG. 1 may include one or more data aggregators. Turning to FIG. 2A, a diagram of data aggregator 102 in accordance with an embodiment is shown. Data aggregator 102 may provide computer-implemented services that utilize data aggregated from various sources within a distributed system. In order to do so, data aggregator 102 may utilize aggregated data without accessing (all of, or a portion thereof) a series of measurements obtained by the sources (e.g., such as data collected by data collectors 100). By doing so, data transmission may be reduced and, therefore, communication bandwidth may be conserved. To provide its functionality, data aggregator 102 may include data manager 200, applications 201, and storage 202. Each of these components is discussed below.

Data manager 200 may (e.g., to provide all, or a portion, of the computer-implemented services): (i) obtain one or more data statistics from sources throughout a distributed system (e.g., from data collectors 100), (ii) obtain one or more inference models and store one or more inference models in inference model repository 204 (and/or other locations), (iii) obtain complementary data statistics using inference models (e.g., those from inference model repository 204), (iv) determine accuracy of the inference models by comparing the data statistic obtained from a distributed system to the complementary data statistic, (v) when the determined accuracy of the inference models falls below a threshold, request at least a portion of a series of measurements from data collectors 100 for purposes that may include re-training inference models, (vi) while the determined accuracy of the inference models meets a threshold, treat the complementary data statistics as being measurements provided by the data collectors 100 and store the inferences used to generate the complementary data statistics in validated data repository 207, (vii) delete data statistics from collected data statistics 205 and complementary data statistics from data statistic inferences 206 (and/or other locations) when no longer needed, and/or (viii) while the determined accuracy of the inference models meets a threshold, perform corrective action to improve the accuracy of future complementary data statistics obtained by the data aggregator using training data 203.

In an embodiment, the data manager 200 may obtain one or more inference models. In one scenario, the data manager 200 may obtain one or more inference models from some entity through a communication system (e.g., communication system 101). In another scenario, one or more inference models may be generated by data manager 200 using training data. In the second scenario, training data may be fed into one or more predictive algorithms including, but not limited to, artificial neural networks, decision trees, support-vector machines, regression analysis, Bayesian networks, and/or genetic algorithms to generate one or more inference models. The inference models may be generated via other methods without departing from embodiments disclosed herein.

To generate an inference model, for example, a training data set may include a set of temperature measurements taken at time intervals in an industrial environment by one or more temperature sensors. Any of the above mentioned inference models (or other predictive algorithms) may be trained using this data set to predict future temperature measurements in the same environment. Data manager 200 may use these trained models to obtain a complementary data statistic based on a set of inferences obtained by the inference model.

Any number of inference models may be stored in the inference model repository 204 (and/or other locations). For example, some inference models may be removed while others may be added. Consequently, the contents of inference model repository 204 may be updated over time to reflect more recent activity of data manager 200.

In an embodiment, data manager 200 may determine accuracy of the inference models by comparing a data statistic obtained from a distributed system to a complementary data statistic, the complementary data statistic being based on a series of inferences obtained by the inference models. In order to determine accuracy of the complementary data statistic, data manager 200 may compare the complementary data statistic to the data statistic obtained from a distributed system. Data manager 200 may determine the complementary data statistic to be accurate if the complementary data statistic falls within an established threshold. The threshold for determining accuracy may be any static or dynamic threshold, may be set by a user, and/or may be obtained from another entity through a communication system (e.g., communication system 101).

For example, the data statistic obtained from a distributed system may be an average temperature over a period of time based on temperature measurements collected by one or more temperature sensors. One data collector may be a temperature sensor that obtains the following measurements at time intervals over the course of one hour: T₁=20° C., T₂=18° C., T₃=17° C., T₄=20° C., T₅=21° C. The data collector may obtain an average temperature value for that hour as T_{avg (measurement)}=19.2° C. by adding the five temperature measurements and dividing by the number of temperature measurements. In this example, the average temperature measurement of 19.2° C. represents the data statistic. By doing so, only a small amount of data may need to be transmitted to data aggregator 102 when compared to the quantity of data that may need to be transmitted to communicate all of the measurements to a data aggregator.

The data manager 200 may obtain a complementary data statistic based on a set of inferences in the form of an average temperature. The data manager 200 may obtain this complementary average temperature without accessing the set of temperature measurements obtained by the temperature sensors. For example, an inference model may obtain the following inferences, inferences being predictions of temperature measurements over the course of one hour: T₁=14° C., T₂=12° C., T₃=13° C., T₄=15° C., T₅=14° C. The data manager may obtain an average temperature inference for that hour as T_{avg (inference)}=13.6° C. by adding the five temperature inferences and dividing by the number of temperature inferences. In this example, the average temperature inference of 13.6° C. represents the complementary data statistic.

The established threshold for accuracy may be, for example, ±5° C. or a different range depending on requirements for the accuracy of aggregated data. If the average temperature obtained by the temperature sensors (T_{avg (measurement)}) was 19.2° C. and the complementary average temperature obtained by the data manager 200 using a set of inferences (T_{avg (inference)}) was 13.6° C., data manager 200 may determine this complementary data statistic to be inaccurate.

An inaccurate complementary statistic may indicate that the inference model requires re-training. For example, using the above scenario with temperature measurements, the data manager 200 may request the full set of temperature measurements from the temperature sensor (T₁=20° C., T₂=18° C., T₃=17° C., T₄=20° C., T₅=21° C.). These temperature measurements may be stored in validated data repository 207, used to re-train inference models, and/or used for other purposes.

In an embodiment, the complementary data statistic may fall within an established static or dynamic threshold and data manager 200 may treat the complementary data statistic as accurate. For example, data manager 200 may obtain a second complementary data statistic based on the following second set of inferences: T₁=19° C., T₂=20° C., T₃=17° C., T₄=22° C., T₅=20° C. The second complementary data statistic may be a second average temperature T_{avg (inference)}=19.6° C. by adding the five temperature inferences and dividing by the number of temperature inferences. In this example, the second average temperature inference of 19.6° C. represents the second complementary data statistic.

The established threshold for accuracy may be ±5° C. If the second T_{avg (measurement)} is 19.2° C. and the second T_{avg (inference)} is 19.6° C., data manager 200 may determine this second complementary data statistic to be accurate. If the second complementary data statistic is accurate, data manager 200 may store the second set of inferences (T₁=19° C., T₂=20° C., T₃=17° C., T₄=22° C., T₅=20° C.) in validated data repository 207, thereby not needing to retrieve copies of the measurements made by the data collector while still having access to a set of data that is representative of the measurements made by the data collector.

Applications 201 may consume data from validated data repository 207 to provide computer-implemented services to users of data aggregator 102 and/or other computing devices operably connected to data aggregator 102. The computer-implemented services may include any type and quantity of services which may utilize, at least in part, data aggregated from a variety of sources (e.g., data collectors 100) within a distributed system.

For example, applications 201 may use the aggregated data to modify industrial manufacturing processes; to sound alerts for undesired operation of systems, locations of persons in an environment; and/or for any other type of purpose. Consequently, the applications 201 may perform various actions (e.g., action sets) based on the data in validated data repository 207 (which may include a combination of measurements from data collectors and inferences rather than data from the data collectors).

In an embodiment, one or more of data manager 200 and applications 201 is implemented using a hardware device including circuitry. The hardware device may be, for example, a digital signal processor, a field programmable gate array, or an application specific integrated circuit. The circuitry may be adapted to cause the hardware device to perform the functionality of data manager 200 and/or applications 201. One or more of data manager 200 and applications 201 may be implemented using other types of hardware devices without departing from embodiments disclosed herein.

In an embodiment, one or more of data manager 200 and applications 201 is implemented using a processor adapted to execute computing code stored on a persistent storage that when executed by the processor performs the functionality of data manager 200 and/or applications 201 discussed throughout this application. The processor may be a hardware processor including circuitry such as, for example, a central processing unit or a microcontroller. The processor may be other types of hardware devices for processing digital information without departing from embodiments disclosed herein.

When providing its functionality, data manager 200 and/or applications 201 may perform all, or a portion, of the operations and/or actions discussed with respect to FIGS. 3A-3B.

When providing its functionality, data manager 200 and/or applications 201 may store data and use data stored in storage 202

In an embodiment, storage 202 is implemented using physical devices that provide data storage services (e.g., storing data and providing copies of previously stored data). The devices that provide data storage services may include hardware devices and/or logical devices. For example, storage 202 may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage 202 may include a memory device (e.g., a dual in line memory device) in which data is stored and from which copies of previously stored data are provided. In another example, storage 202 may include a persistent storage device (e.g., a solid-state disk drive) in which data is stored and from which copies of previously stored data is provided. In a still further example, storage 202 may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

Storage 202 may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

Storage 202 may store data structures including, for example, training data 203, inference model repository 204, collected data statistics 205, data statistics inferences 206, and validated data repository 207. Any of these data structures is usable by components of the system in FIG. 1. Any of these data structures may be implemented using, for example, lists, tables, databases, linked lists, and/or other type of data structures. Any of the data structures may be shared, spanned across multiple devices, and may be maintained and used by any number of entities. Additionally, while illustrated as including a limited amount of specific data, any of these data structures may include additional, less, and/or different data without departing from embodiments disclosed herein. Each of these data structures is discussed below.

In an embodiment, training data 203 includes training data usable to train a machine learning model (and/or other type of inference-generation models). Training data 203 may be obtained from various sources throughout a distributed system (e.g., from data collectors 100) and may include (all of, or a portion thereof) a series of measurements representing an ambient environment and/or other types of measurements.

For example, training data 203 may include a set of temperature measurements taken at time intervals in an industrial environment by one or more temperature sensors. Temperature sensors may collect a set of temperature measurements at various time intervals over any period of time. For example, one temperature sensor may record the following data over the course of one hour: T₁=21° C., T₂=19° C., T₃=18° C., T₄=22° C., T₅=20° C. These temperature measurements may be temporarily or permanently stored by the temperature sensor and transmitted to a central temperature control system when requested for purposes of training a machine-learning model to predict future temperature measurements in the same environment (and/or other purposes).

In an embodiment, inference model repository 204 includes one or more inference models. The inference models may be trained using training data 203 to generate complementary data statistics.

In an embodiment, the inference models are obtained by feeding training data 203 into a machine learning (e.g., a deep learning) model. In an embodiment, a deep learning-based model is used to predict future measurements collected by data collectors 100 without having access to the series of measurements.

For example, any number of temperature sensors throughout a distributed system in an industrial environment may record temperature measurements at various time intervals. Over any period of time, these temperature measurements may be collected and transmitted to a central temperature control system. The central temperature control system may utilize the set of temperature measurements for the purpose of training a machine-learning model to predict future temperature measurements in the same environment.

The central temperature control system may train the machine-learning model to predict a complementary data statistic (and/or underlying data used to generate a data statistic) for every hour that the temperature sensors are measuring data. For example, the inference model may be trained to predict an average temperature reading for every hour. The inference model may predict an average temperature value of 20° C. for the second hour of temperature measurements without obtaining any temperature measurements from the temperature sensor.

Collected data statistics 205 may include any number of data statistics obtained from various sources within a distributed system (e.g., data collectors 100). The data statistic may be a reduced-size representation of a series of measurements recorded by data collectors 100. The data statistic may be, for example, an average of the series of measurements performed by the data collector, a mode of the series of measurements performed by the data collector, and/or a median of the series of measurements performed by the data collector (and/or other representations). The data statistic may be other types of reduced-sized representations of data without departing from embodiment disclosed herein.

To obtain a data statistic, for example, one data collector may include a temperature sensor that records the following measurements at time intervals over the course of one hour: T₁=21° C., T₂=19° C., T₃=18° C., T₄=22° C., T₅=20° C. The data collector may obtain an average temperature value for that hour as T_{avg (measurement)}=20° C. by adding the five temperature measurements and dividing by the number of temperature measurements. In this example, the average temperature measurement of 20° C. represents the data statistic.

Data statistic inferences 206 may include any number of complementary data statistics obtained by data manager 200. The complementary data statistics may be generated by an inference model from inference model repository 204. The complementary data statistic may be, for example, an average of the series of inferences obtained by data manager 200, a mode of the series of inferences obtained by data manager 200, or a median of the series of inferences obtained by data manager 200 (and/or other representations). The complementary data statistic may be other types of reduced-sized representations of data without departing from embodiment disclosed herein.

To obtain a complementary statistic, for example, an inference model may obtain the following inferences, inferences being predictions of temperature measurements over the course of one hour: T₁=20° C., T₂=18° C., T₃=21° C., T₄=22° C., T₅=19° C. The data manager may obtain an average temperature inference for that hour as T_{avg (inference)}=20° C. by adding the five temperature inferences and dividing by the number of temperature inferences. In this example, the average temperature inference of 20° C. represents the complementary data statistic.

In an embodiment, validated data repository 207 includes any number of measurements obtained from data collectors (e.g., data collectors 100) and inferences obtained by data manager 200. For example, data manager 200 may obtain a complementary data statistic generated using an inference model. This complementary data statistic may represent a series of inferences generated by data manager 200. Data manager 200 may compare this complementary data statistic to a data statistic obtained from data collectors 100 and determine accuracy based on some established static or dynamic threshold. If accurate, the inferences used to obtain the complementary data statistic may be moved to the validated data repository 207 and treated as a series of measurements obtained from data collectors 100. By doing so, data aggregator 102 may gain access to data representing a series of measurements without needing to transmit the series of measurements. Rather, only a reduced-size representation may be transmitted. Accordingly, the disclosed system may facilitate access to data in a distributed system while reducing communication bandwidth and/or energy use for data distribution in the distributed system.

Continuing with the above example, data manager 200 may obtain an average temperature inference of T_{avg (inference)}=20° C. by adding the temperature inferences and dividing by the number of temperature inferences. Data manager 200 may also obtain an average temperature measurement from data collectors 100. As described above, data manager 200 may obtain an average temperature measurement of T_{avg (measurement)}=20° C. Data manager 200 may compare T_{avg (inference)} to T_{avg (measurement)} to determine accuracy of the inference model.

Continuing with the above example, the established threshold for accuracy may be ±5° C. If T_{avg (inference)} falls outside of that threshold, data manager may determine it to be inaccurate. In a first scenario, data manager 200 may find T_{avg (inference)} accurate, as T_{avg (inference)} falls within the established threshold of ±5° C. As a result, the set of inferences (T₁=20° C., T₂=18° C., T₃=21° C., T₄=22° C., T₅=19° C.) may be moved to validated data repository 207 and treated as measurements collected by data collectors 100.

In a second scenario, a second T_{avg (inference)} may be based on the following second set of inferences: T₁=22° C., T₂=24° C., T₃=20° C., T₄=25° C., T₅=20° C. The data manager may obtain a second average temperature inference for that hour as T_{avg (inference)}=22.2° C. by adding the five temperature inferences and dividing by the number of temperature inferences. In this example, the second average temperature inference of 22.2° C. represents the second complementary data statistic.

Continuing with the second scenario, data manager 200 may obtain the second complementary data statistic of T_{avg (inference)}=22.2° C. and a second average temperature measurement T_{avg (measurement)}=15° C. The second T_{avg (measurement)} may be based on the following series of measurements collected by a second temperature sensor: T₁=15° C., T₂=17° C., T₃=14° C., T₄=17° C., T₅=12° C. by adding the series of measurements and dividing by the number of measurements.

Data manager 200 may compare the second T_{avg (inference)} to the second T_{avg (measurement)} to determine accuracy of the inference model. The established threshold for accuracy may be ±5° C. If the second T_{avg (inference)} falls outside of that threshold, data manager may determine it to be inaccurate. In this scenario, data manager 200 may find the second T_{avg (inference)} inaccurate, as the second T_{avg (inference)} falls outside the established threshold of ±5° C. As a result, the second set of inferences may be deleted and data manager 200 may request the second series of measurements from the second temperature sensor (T₁=15° C., T₂=17° C., T₃=14° C., T₄=17° C., T₅=12° C.). This second series of measurements may be stored in validated data repository 207 and/or used for re-training purposes.

While illustrated in FIG. 2A as including a limited number of specific components, a data aggregator in accordance with an embodiment may include fewer, additional, and/or different components than shown in FIG. 2A.

As discussed above, the system of FIG. 1 may include one or more data collectors (e.g., data collectors 100A-100N). Turning to FIG. 2B, a diagram of data collector 100A in accordance with an embodiment is shown. Data collector 100A may provide data collection services to users and/or other computing devices operably connected to data collector 100A. The data collection services may include any type and quantity of services including, for example, temperature data collection, pH data collection, humidity data collection, etc. Following data collection, data collector 100A may generate a reduced-size representation (e.g., a data statistic) of the series of measurements and transmit the data statistic to data aggregator 102 in place of the full series of measurements. By doing so, the amount of data transmitted throughout a distributed system may be reduced, which may lead to a reduction in communication bandwidth consumption and energy consumption throughout the system. To provide its functionality, data collector 100A may include sensor 208, data control 209, and storage 210. Each of these components is described below.

Sensor 208 may obtain a series of measurements representing a characteristic of an ambient environment. For example, sensor 208 may be a temperature sensor positioned in an industrial environment to obtain temperature measurements at various time intervals over the course of each hour. For example, sensor 208 may obtain the following series of measurements over the course of the first hour of data collection: T₁=22° C., T₂=20° C., T₃=18° C., T₄=22° C., T₅=19° C. Sensor 208 may store at least a portion of these measurements in storage 210 (and/or other locations).

Data control 209 may (e.g., to provide all, or a portion of the data collection services): (i) obtain live data from storage 210 (and/or other locations), (ii) obtain one or more data statistics as a reduced-size representation of live data, (iii) transmit one or more data statistics to data aggregator 102, (iv) respond to commands received from data aggregator 102.

In an embodiment, data control 209 may obtain one or more data statistics, a data statistic being a reduced-size representation of live data obtained by sensor 208 (and/or other sources). For example, live data may include temperature measurements obtained by a temperature sensor (e.g., sensor 208). The temperature sensor may obtain the following set of measurements over the course of an hour: T₁=22° C., T₂=20° C., T₃=18° C., T₄=22° C., T₅=19° C. and store at least a portion of these measurements in storage 210 (and/or other locations). Data control 209 may obtain this set of measurements in order to generate a data statistic.

In an embodiment, a data statistic may include any reduced-size representation of a set of measurements. The data statistic may be, for example, an average of a series of measurements performed by a data collector, a mode of a series of measurements performed by a data collector, and/or a median of a series of measurements performed by a data collector (and/or other representations). The data statistic may be other types of reduced-sized representations of data without departing from embodiments disclosed herein.

To obtain a data statistic, data control 209 may, for example, obtain an average temperature measurement by adding the temperature measurements and dividing by the number of temperature measurements. To do so, data control may obtain the following temperature measurements from sensor 208 over the course of an hour: T₁=22° C., T₂=20° C., T₃=18° C., T₄=22° C., T₅=19° C. Data control 209 may obtain an average temperature measurement for that hour as T_{avg (measurement)}=20.2° C. by adding the five temperature measurements and dividing by the number of temperature measurements. In this example, the average temperature measurement of 20.2° C. represents the data statistic.

In an embodiment, data control 209 may transmit one or more data statistics to data aggregator 102. Data control 209 may transmit one or more data statistics at time intervals designated by a user and/or another entity through a communication system (e.g., communication system 101). For example, data control 209 may transmit an average temperature value to data aggregator 102 once every hour.

In an embodiment, data control 209 may respond to commands from data aggregator 102. In a first scenario, data aggregator 102 may request data statistics (and/or other reduced-sized representations of measurements) at specific time intervals from data control 209. In a second scenario, data aggregator 102 may also request at least a portion of a series of measurements from data collector 100A for purposes of training or re-training inference models (and/or other purposes). In a third scenario, data aggregator 209 may request measurements and/or data statistics be deleted from storage 210.

For example, data aggregator 102 may request an average temperature measurement be transmitted every hour from data control 209. Data aggregator may also request a full set of temperature measurements over the course of an hour if the complementary data statistic is determined inaccurate (and/or other reasons).

In an embodiment, one or more of sensor 208 and data control 209 is implemented using a hardware device including circuitry. The hardware device may be, for example, a digital signal processor, a field programmable gate array, or an application specific integrated circuit. The circuitry may be adapted to cause the hardware device to perform the functionality of sensor 208 and/or data control 209. One or more of sensor 208 and data control 209 may be implemented using other types of hardware devices without departing from embodiments disclosed herein.

In an embodiment, one or more of sensor 208 and data control 209 is implemented using a processor adapted to execute computing code stored on a persistent storage that when executed by the processor performs the functionality of sensor 208 and/or data control 209 discussed throughout this application. The processor may be a hardware processor including circuitry such as, for example, a central processing unit or a microcontroller. The processor may be other types of hardware devices for processing digital information without departing from embodiments disclosed herein.

In an embodiment, sensor 208 and/or data control 209 may utilize a physical device (e.g., a sensor) used to measure a characteristic of an ambient environment in order to perform the functionality of sensor 208 and/or data control 209. For example, a temperature sensor may utilize one or more thermistors, thermocouples, and/or resistance temperature detectors to collect temperature data. In a second example, a pH sensor may utilize any number of electrodes to collect pH data. The sensor may include other types of hardware devices for measuring a characteristic of an ambient environment without departing from embodiments disclosed herein.

When providing their functionality, sensor 208 and data control 209 may perform all, or a portion, of the operations and/or actions discussed with respect to FIGS. 3C-3D.

When providing its functionality, data control 209 may store data and use data stored in storage 210.

In an embodiment, storage 210 is implemented using physical devices that provide data storage services (e.g., storing data and providing copies of previously stored data). The devices that provide data storage services may include hardware devices and/or logical devices. For example, storage 210 may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage 210 may include a memory device (e.g., a dual in line memory device) in which data is stored and from which copies of previously stored data are provided. In another example, storage 210 may include a persistent storage device (e.g., a solid-state disk drive) in which data is stored and from which copies of previously stored data is provided. In a still further example, storage 210 may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

Storage 210 may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

Storage 210 may store data structures including, for example, live data 211 and data statistics 212. Any of these data structures is usable by components of the system in FIG. 1. Any of these data structures may be implemented using, for example, lists, tables, databases, linked lists, and/or other type of data structures. Any of the data structures may be shared, spanned across multiple devices, and may be maintained and used by any number of entities. Additionally, while illustrated as including a limited amount of specific data, any of these data structures may include additional, less, and/or different data without departing from embodiments disclosed herein. Each of these data structures is discussed below.

In an embodiment, live data 211 includes live data measurements collected by sensor 208. For example, live data 211 may include temperature measurements recorded by a temperature sensor at various time intervals. A series of temperature measurements may include the following five measurements taken over the course of one hour: T₁=20° C., T₂=19° C., T₃=17° C., T₄=21° C., T₅=19° C. Any amount of measurements may be stored temporarily and/or permanently in live data 211 (and/or other locations). For example, some measurements may be removed while others may be added. Consequently, the contents of live data 211 may be updated over time to reflect more recent activity of data control 209.

In an embodiment, data statistics 212 includes any number of data statistics obtained by data control 209. A data statistic may be any reduced-size representation of a series of measurements, including an average of a series of measurements, a mode of a series of measurements, and/or a median of a series of measurements (and/or other representations).

For example, data statistics 212 may store any number of average temperature measurements, each average temperature measurement representing a series of temperature measurements. To obtain an average temperature measurement, for example, sensor 208 may collect the following series of temperature measurements over the course of one hour: T₁=20° C., T₂=19° C., T₃=17° C., T₄=21° C., T₅=19° C. Data control 209 may obtain an average of these measurements by adding the measurements and dividing by the number of measurements. Therefore, the average temperature measurement may be 19.2° C. In this example, the average temperature measurement of 19.2° C. represents the data statistic that is stored in data statistics 212. Any amount of data statistics may be stored temporarily or permanently in data statistics 212 (and/or other locations). For example, some data statistics may be removed while others may be added. Consequently, the contents of data statistics 212 may be updated over time to reflect more recent activity of data control 209.

While illustrated in FIG. 2B as including a limited number of specific components, a data collector in accordance with an embodiment may include fewer, additional, and/or different components than shown in FIG. 2B.

As discussed above, the components of FIG. 1 may perform various methods to utilize data aggregated from various sources throughout a distributed system. FIGS. 3A-3D illustrate methods that may be performed by the components of FIG. 1. In the diagrams discussed below and shown in FIGS. 3A-3D, any of the operations may be repeated, performed in different orders, and/or performed in parallel with or in a partially overlapping in time manner with other operations.

Turning to FIG. 3A, a flow diagram illustrating a method of validating inferences generated by an inference model in accordance with an embodiment is shown.

At operation 300, a training data set is obtained. The training data set may include any quantity and type of data. For example, the training data set may include a series of measurements representing an ambient environment (e.g., temperature data, humidity data, pH data).

In an embodiment, the training data set may be obtained from any number of data collectors throughout a distributed system. For example, requests for the data may be sent to the data collectors and the data collectors may provide the data to the data aggregator in response to the requests. Such messages and/or data may be passed via a communication system operably connecting the data collector and the data aggregator.

In an embodiment, the training data set may be provided by another entity through a communication system. For example, the training data may be obtained by data collectors throughout a second distributed system with a similar environment. This training data set may be provided to any number of data aggregators in any number of distributed systems.

At operation 301, an inference model is obtained. The inference model may be implemented with, for example, a machine learning model. The inference model may generate inferences that predict future measurements obtained by data collectors without having access to the measurements obtained by the data collectors.

In an embodiment, the inference model is obtained by the data aggregator using a training data set. The training data set may be fed into a machine learning model (and/or other type of inference generation model) to obtain the inference model to predict future measurements from data collectors.

In an embodiment, the inference model may also be obtained from another entity through a communication system. For example, an inference model may be obtained by another entity through training a machine learning model and providing the trained machine learning model to the data aggregator. In this scenario, the inference model may or may not require training by the data aggregator.

At operation 302, a series of inferences are generated using the trained inference model and a complementary data statistic is obtained based on the series of inferences. The inferences may be predictions of a series of measurements collected by data collectors throughout a distributed system. The series of inferences may be generated without the data aggregator having access to any measurements from any data collectors.

The complementary data statistic may be any reduced-size representation of the series of inferences. The data statistic may be, for example, an average of the series of measurements performed by the data collector, a mode of the series of measurements performed by the data collector, and/or a median of the series of measurements performed by the data collector (and/or other representations). The complementary data statistics may be other types of reduced-size representations without departing from embodiments disclosed herein.

In an embodiment, in order to further reduce data transmission, any transmitted data statistics may be subject to quantization to reduce the quantity of bits necessary to transmit the data statistic. For example, the data statistics may be rounded to whole integers, the nearest tenth, etc. By doing so, fewer bits may be needed to be transmitted to represent the quantized data statistic.

At operation 303, a data statistic is obtained from a data collector. The data statistic may be any reduced-size representation of a series of measurements (which the inference model attempts to predict) collected by the data collector. The data statistic may be, for example, an average of the series of measurements performed by the data collector, a mode of the series of measurements performed by the data collector, and/or a median of the series of measurements performed by the data collector (and/or other representations).

In an embodiment, the data statistic may be obtained from any number of data collectors throughout a distributed system. For example, requests for the data statistic may be sent to the data collectors and the data collectors may provide the data statistic to the data aggregator in response to the requests. Such messages and/or data may be passed via a communication system operably connecting the data collector and the data aggregator.

In an embodiment, the data statistic may be provided by the data collectors to the data aggregator. The data collectors may be programmed to provide data statistics at established time intervals. For example, the data collectors may be programmed to provide a data statistic once every hour.

As will be discussed below, the data statistic may be used to determine whether the series of inferences on which the complementary data statistic is based are accurate.

Turning to FIG. 3B, a flow diagram illustrating a method of validating inferences generated by an inference model in accordance with an embodiment is shown. FIG. 3B may be a continuation of the method illustrated in 3A.

At operation 304, it is determined whether the complementary data statistic based on a series of inferences matches the data statistic based on a series of measurements recorded by the data collector. A complementary data statistic may be determined accurate if it falls within an established threshold. The threshold for accuracy may be obtained from a user, from another entity through a communication system, or via other methods. If the complementary data statistic matches the data statistic within the established threshold, the method may proceed to operation 307. If the complementary data statistic does not match the data statistic within the established threshold, the method may proceed to operation 305.

At operation 307, the complementary data statistic matches the data statistic within the established threshold. In this scenario, the inferences generated by the inference model are stored as validated data. The data aggregator may treat these validated inferences as data collected by the data collector even though no actual data was obtained from the data collector. The data collector may be allowed to discard the series of measurements without transmitting them to the data aggregator.

The method may end following operation 307.

Returning to operation 304, the method may proceed to operation 305 when the complementary data statistic does not match the data statistic within the established threshold.

At operation 305, the complementary data statistic does not match the data statistic within the established threshold. In this scenario, at least a portion of the series of measurements from the data collector are obtained. The inferences generated by the inference model may be determined inaccurate and may be discarded. The data aggregator may request at least a portion of the series of measurements obtained by the data collector in order to store them as validated data (and/or for other purposes).

At operation 306, the inference model is updated. If the complementary data statistic is determined inaccurate, the inference model may require updating to improve the accuracy of the predictions. The inference model may be updated using a second set of training data. The second set of training data may be obtained from the validated data, which may include both inferences and actual measurements from data collectors. The data aggregator may request a second set of training data from the data collectors or obtain this second set of training data from another entity through a communication system operably connecting the data collector and the data aggregator.

The method may end following operation 306.

While described herein with respect to the data aggregator performing the comparison between statistics, a data collector may perform such comparisons without departing from embodiments disclosed herein. To do so, the complementary data statistic may instead be transmitted to the data collector. Once the comparison is complete, the data collector may then manage the response to the comparison such as providing a series of measurements to the data aggregator and/or initiating updating of inference models.

Turning to FIG. 3C, a flow diagram illustrating a method of data collection in accordance with an embodiment is shown.

At operation 308, a series of measurements is obtained. The series of measurements may represent some characteristic of an ambient environment. For example, the series of measurements may include temperature data, pH data, humidity data, etc. The series of measurements may be obtained by a data collector continuously, at established time intervals, and/or via other modalities.

At operation 309, a data statistic is obtained. The data statistic may include any reduced-size representation of (all or a portion of) the series of measurements. The data statistic may be, for example, an average of the series of measurements performed by the data collector, a mode of the series of measurements performed by the data collector, and/or a median of the series of measurements performed by the data collector (and/or other representations). The data statistic may be obtained over an established time interval. For example, the data collectors may obtain a data statistic once every hour. The data statistics may be other types of reduced-size representations obtained at other time intervals without departing from embodiments disclosed herein.

At operation 310, the data statistic is transmitted to the data aggregator. The data statistic may be transmitted to the data aggregator via a communication system. As mentioned above, the data statistic may be obtained at an established time interval. The data statistic may also be transmitted at the same (or any other) time interval to the data aggregator.

The series of measurements and/or the data statistic may be stored by the data collector permanently or temporarily. The data collector may determine whether to transmit additional data to the data aggregator by responding to requests from the data aggregator. The data collector may also determine whether to discard the series of measurements and/or data statistic by responding to requests from the data aggregator. Unless the data collector obtains an indication that the series of measurements is to be provided to the data aggregator, the data collector may presume that data aggregator was able to obtain a representation of the series of measurements without need to receive copies of the measurements of the series of measurements.

Turning to FIG. 3D, a flow diagram illustrating a method of data management in accordance with an embodiment is shown. FIG. 3D may be a continuation of the method illustrated in 3C.

At operation 311, it is determined whether the data aggregator requests at least a portion of the series of measurements. The data aggregator may determine whether to request additional data from the data collector by comparing the data statistic to a complementary data statistic obtained by the data aggregator using an inference model. If the complementary data statistic is determined accurate, then the data aggregator may not request the at last the portion of the series of measurements. Refer to FIG. 3B, operations 304-307 for additional details regarding data aggregator operation.

If the data aggregator does not request the at least the portion of the series of measurements, then the method may proceed to operation 312. If the data aggregator does request the at least the portion of the series of measurements, then the method may proceed to operation 313.

At operation 312, the data aggregator does not request at least a portion of the series of measurements. In this scenario, the data collector discards the series of measurements and/or the data statistic without transmitting any additional data to the data aggregator.

In an embodiment, the data aggregator may not request any portion of the series of measurements following the determination that the complementary data statistic is accurate. In order to determine accuracy of the complementary data statistic, the data aggregator may compare the complementary data statistic to the data statistic obtained from the data collector. If the complementary data statistic matches the data statistic within an established threshold, the inference model may be determined accurate. If the inference model is determined accurate, the inferences obtained by the data aggregator may be stored as validated data without any actual data being transmitted from the data collector. Limiting data transmissions may preserve communication bandwidth and reduce energy consumption due to data transmission throughout the system shown in FIG. 1.

The method may end following operation 312.

Returning to operation 311, the method may proceed to operation 313 when the data aggregator requests at least a portion of the series of measurements. In this scenario, the data collector transmits at least a portion of the series of measurements to the data aggregator. The series of measurements may be transmitted to the data aggregator via a communication system.

In an embodiment, the data aggregator may request at least a portion of the series of measurements from the data collector following the determination that the complementary data statistic is inaccurate. As discussed above, the data aggregator may compare the complementary data statistic to the data statistic obtained from the data collector. If the complementary data statistic does not match the data statistic within an established threshold, the inference model may be determined inaccurate. The series of measurements transmitted by the data collector may be stored by the data aggregator as validated data.

In an embodiment, the data aggregator may request at least a portion of the series of measurements from the data collector for other purposes. For example, the data aggregator may determine that the inference model requires re-training and/or other types of modifications to improve its accuracy. In this scenario, the data aggregator may request additional measurements from the data collector and/or obtain inferences from validated data to use as training data to re-train the inference model. The data aggregator may request additional measurements from the data collector for other purposes without departing from embodiments disclosed herein.

The method may end following operation 312.

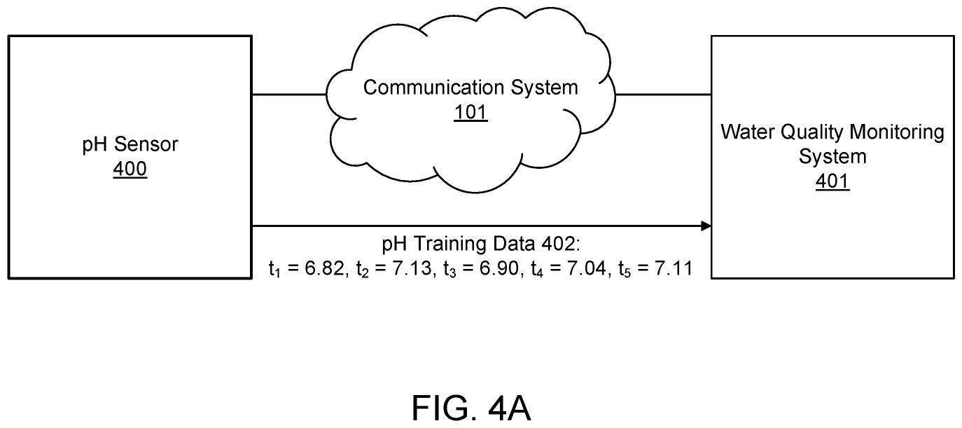

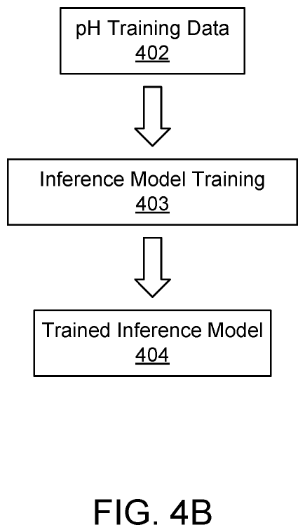

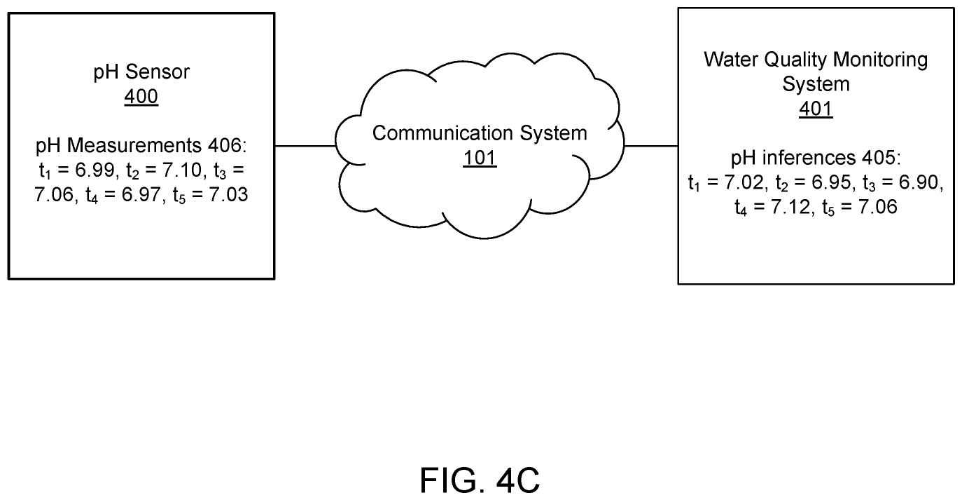

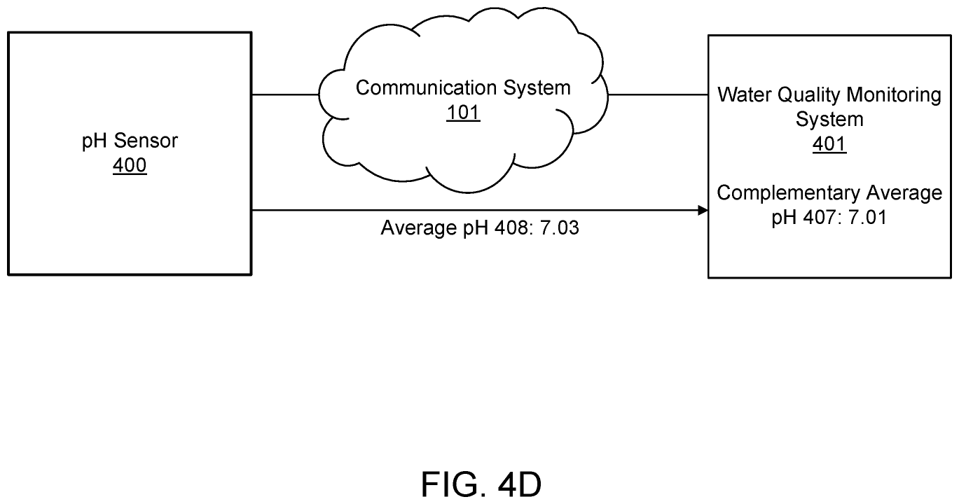

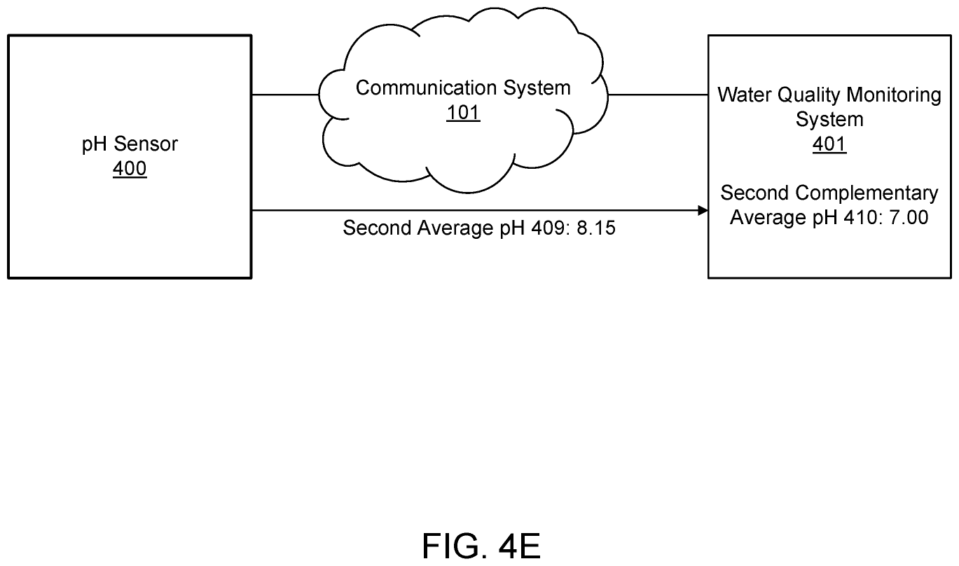

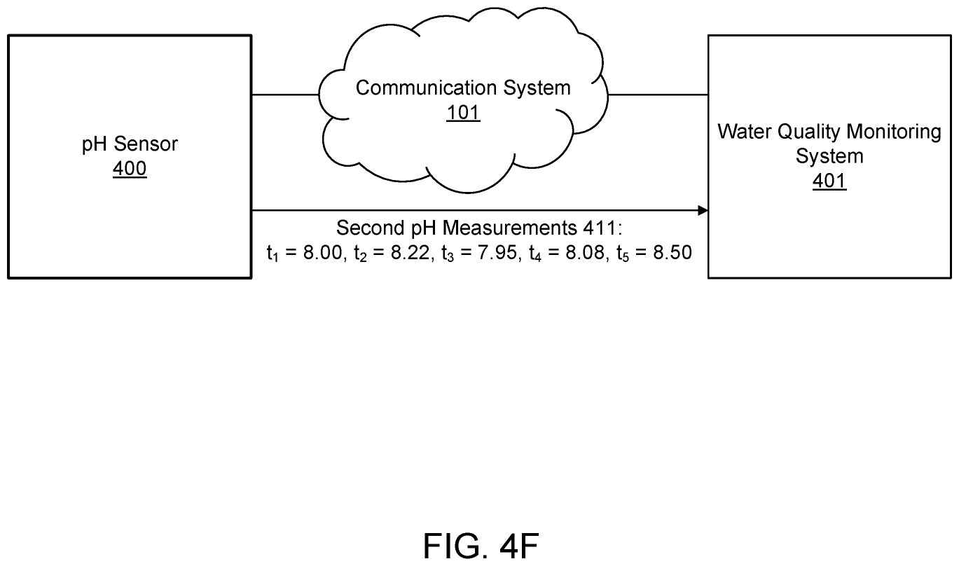

Turning to FIGS. 4A-4F, these figures may illustrate a system similar to that of FIG. 1 in accordance with an embodiment. FIGS. 4A-4F may show actions performed by the system over time. The system may include potential of hydrogen (pH) sensor 400 and water quality monitoring system 401. pH sensor 400 may be operably connected to water quality monitoring system 401 via communication system 101. Communication system 101 may include limited communication bandwidth and may serve a large number of different components (not shown). Consequently, it may be desirable to limit communications between pH sensor 400 and water quality monitoring system 401 to efficiently marshal the limited communication bandwidth so that it is less likely that components of the system are impaired for lack of access to communication bandwidth.

Turning to FIG. 4A, consider a scenario where pH sensor 400 collects pH training data 402 from a water sample. pH training data 402 may be collected at various time intervals (e.g., t₁, t₂, etc.) over the course of one hour and may include the following: t₁=6.82, t₂=7.13, t₃=6.90, t₄=7.04, t₅=7.11 (e.g., on a scale of 0 to 14 with a score of 7 indicating neutrality, scores below 7 indicating acidity, and scores above 7 indicating base conditions). Water quality monitoring system 401 may obtain pH training data 402 for the purpose of training an inference model to predict future pH measurements obtained by pH sensor 400.

Water quality monitoring system 401 may train an inference model based on pH training data 402 to obtain a trained inference model. Turning to FIG. 4B, an inference training process is illustrated where pH training data 402 may be used to perform an inference model training 403 process to obtain the trained inference model 404. For example, water quality management system 401 may perform portions of the methods illustrated in FIGS. 3A and 3B to obtain trained inference model 404.

Turning to FIG. 4C, pH sensor 400 may obtain the following second set of pH measurements (e.g., pH measurements 406): t₁=6.99, t₂=7.10, t₃=7.06, t₄=6.97, t₅=7.03.

With trained inference model 404, water quality management system 401 may obtain the following pH inferences 405: t₁=7.02, t₂=6.95, t₃=6.90, t₄=7.12, t₅=7.06 as predictions of pH measurements obtained by pH sensor 400. Water quality management system 401 may obtain pH inferences 405 without having access to pH measurements 406.

Turning to FIG. 4D, water quality management system 401 may obtain a complementary data statistic based on pH inferences 405. In this scenario, the complementary data statistic may be complementary average pH 407, where complementary average pH 407 may be an average of the pH inferences 405. Complementary average pH 407 may be obtained by adding the values of the pH inferences and dividing by the number of pH inferences to obtain an average value of 7.01.

Water quality management system 401 may obtain a data statistic from pH sensor 400 based on a second set of pH measurements 406. In this scenario, the data statistic may be average pH 408, where average pH 408 may be an average of the pH measurements 406. Average pH 408 may be obtained by adding the values of the pH measurements and dividing by the number of pH measurements to obtain an average value of 7.03. Average pH value 408 may be used to determine whether the series of inferences on which complementary average pH 407 is based are accurate.

Water quality monitoring system 401 may use an established threshold to determine accuracy of the inference model. For example, the established threshold may be ±0.5. In this scenario, water quality monitoring system 401 may determine the inferences accurate, as they fall within the established threshold. The set of pH inferences 405 may then be stored as validated data and treated as pH measurements obtained by pH sensor 400. By doing so, only the average pH 408 may be transmitted over the communication system 101 rather than the entirety of pH measurements 406. By doing so, the bandwidth use of communication system 101 may be reduced by not needing to carry information regarding the pH measurements 406 from pH sensor 400 to water quality monitoring system 401 while water quality monitoring system 401 is still able to operate as though it had access to pH measurements 406.

Turning to FIG. 4E, second average pH 409 and second complementary average pH 410 may be obtained using the same method described for average pH 408 and complementary average pH 407. Water quality monitoring system 401 may use the same threshold of ±0.5 to compare the second average pH 409 value of 8.15 and the second complementary average pH 410 value of 7.00. The inferences may be determined inaccurate, as the second complementary average pH 410 value does not fall within the established threshold. Water quality monitoring system 401 may take corrective action in order to improve the accuracy of the inference model.

Turning to FIG. 4F, water quality monitoring system 401 may request the full set of pH measurements used to obtain second average pH 409 from pH sensor 400. pH sensor 400 may transmit the following second pH measurements 411: t₁=8.00, t₂=8.22, t₃=7.95, t₄=8.08, t₅=8.50 via communication system 101. pH sensor 400 may discard second pH measurements 411 following transmission. Water quality monitoring system 401 may store second pH measurements 411 as validated data and/or use at least a portion of this data set to re-train the inference model. By doing so, the accuracy of the inference model may be improved to predict future pH measurements. Consequently, the bandwidth use of communication system 101 may be reduced by reducing the likelihood of needing to carry information regarding future pH measurements from pH sensor 400 to water quality monitoring system 401 while water quality monitoring system 401 is still able to operate as though it had access to future pH measurements.

Any of the components illustrated in FIGS. 1-4F may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing data collection, comprising:
obtaining, from a data collector, a data statistic, the data statistic being based on a series of measurements performed by the data collector;
making a determination that the data statistic does not match a complementary statistic obtained by a data aggregator that does not have access to the series of measurements when the complementary statistic is obtained, the complementary statistic being based on a series of inferences generated by the data aggregator;
based on the determination:
treating the series of inferences as being inaccurate; and
obtaining at least a portion of the series of measurements from the data collector.

2. The method of claim 1, further comprising:
obtaining, from a data collector, a second data statistic, the second data statistic being based on a second series of measurements performed by the data collector;
making a second determination that the second data statistic matches a second complementary statistic obtained by the data aggregator that does not have access to the second series of measurements when the second complementary statistic is obtained, the second complementary statistic being based on a second series of inferences generated by the data aggregator;
based on the second determination:
treating the second series of inferences as being accurate; and
allowing the data collector to discard the second series of measurements without providing the data aggregator with the second series of measurements.

3. The method of claim 1, further comprising:
based on the determination:
updating an inference model that was used to obtain the series of inferences generated by the data aggregator, the updating performed using a training data set comprising, at least in in part, a portion of the series of inferences generated by the data aggregator and the at least the portion of the series of measurements from the data collector.

4. The method of claim 1, wherein the series of inferences is generated by the data aggregator using an inference model trained using a training data set, the training data set comprising a second series of measurements performed by the data collector, the second series of measurements being performed prior to the series of measurements.

5. The method of claim 1, wherein the data statistic comprises one selected from a group consisting of an average of the series of measurements performed by the data collector, a mode of the series of measurements performed by the data collector, and a median of the series of measurements performed by the data collector.

6. The method of claim 1, wherein the series of measurements are obtained using a sensor that measures a characteristic of an ambient environment.

7. The method of claim 1, wherein the series of inferences are generated using an inference model trained to duplicate the series of measurements, the inference model being hosted by the data aggregator.

8. A non-transitory machine-readable medium having instructions stored therein, which when executed by a processor, cause the processor to perform operations for managing data collection, the operations comprising:
obtaining, from a data collector, a data statistic, the data statistic being based on a series of measurements performed by the data collector;
making a determination that the data statistic does not match a complementary statistic obtained by a data aggregator that does not have access to the series of measurements when the complementary statistic is obtained, the complementary statistic being based on a series of inferences generated by the data aggregator;
based on the determination:
treating the series of inferences as being inaccurate; and
obtaining at least a portion of the series of measurements from the data collector.

9. The non-transitory machine-readable medium of claim 8, further comprising:
obtaining, from a data collector, a second data statistic, the second data statistic being based on a second series of measurements performed by the data collector;
making a second determination that the second data statistic matches a second complementary statistic obtained by the data aggregator that does not have access to the second series of measurements when the second complementary statistic is obtained, the second complementary statistic being based on a second series of inferences generated by the data aggregator;
based on the second determination:
treating the second series of inferences as being accurate; and
allowing the data collector to discard the second series of measurements without providing the data aggregator with the second series of measurements.

10. The non-transitory machine-readable medium of claim 8, further comprising:
based on the determination:
updating an inference model that was used to obtain the series of inferences generated by the data aggregator, the updating performed using a training data set comprising, at least in in part, a portion of the series of inferences generated by the data aggregator and the at least the portion of the series of measurements from the data collector.

11. The non-transitory machine-readable medium of claim 8, wherein the series of inferences is generated by the data aggregator using an inference model trained using a training data set, the training data set comprising a second series of measurements performed by the data collector, the second series of measurements being performed prior to the series of measurements.

12. The non-transitory machine-readable medium of claim 8, wherein the data statistic comprises one selected from a group consisting of an average of the series of measurements performed by the data collector, a mode of the series of measurements performed by the data collector, and a median of the series of measurements performed by the data collector.

13. The non-transitory machine-readable medium of claim 8, wherein the series of measurements are obtained using a sensor that measures a characteristic of an ambient environment.

14. The non-transitory machine-readable medium of claim 8, wherein the series of inferences are generated using an inference model trained to duplicate the series of measurements, the inference model being hosted by the data aggregator.

15. A data aggregator, comprising:
a processor; and
a memory coupled to the processor to store instructions, which when executed by the processor, cause the processor to perform operations for managing data collection, the operations comprising:
obtaining, from a data collector, a data statistic, the data statistic being based on a series of measurements performed by the data collector;
making a determination that the data statistic does not match a complementary statistic obtained by a data aggregator that does not have access to the series of measurements when the complementary statistic is obtained, the complementary statistic being based on a series of inferences generated by the data aggregator;
based on the determination:
treating the series of inferences as being inaccurate; and
obtaining at least a portion of the series of measurements from the data collector.

16. The data aggregator of claim 15, further comprising:
obtaining, from a data collector, a second data statistic, the second data statistic being based on a second series of measurements performed by the data collector;
making a second determination that the second data statistic matches a second complementary statistic obtained by the data aggregator that does not have access to the second series of measurements when the second complementary statistic is obtained, the second complementary statistic being based on a second series of inferences generated by the data aggregator;
based on the second determination:
treating the second series of inferences as being accurate; and
allowing the data collector to discard the second series of measurements without providing the data aggregator with the second series of measurements.

17. The data aggregator of claim 15, further comprising:
based on the determination:
updating an inference model that was used to obtain the series of inferences generated by the data aggregator, the updating performed using a training data set comprising, at least in in part, a portion of the series of inferences generated by the data aggregator and the at least the portion of the series of measurements from the data collector.

18. The data aggregator of claim 15, wherein the series of inferences is generated by the data aggregator using an inference model trained using a training data set, the training data set comprising a second series of measurements performed by the data collector, the second series of measurements being performed prior to the series of measurements.

19. The data aggregator of claim 15, wherein the data statistic comprises one selected from a group consisting of an average of the series of measurements performed by the data collector, a mode of the series of measurements performed by the data collector, and a median of the series of measurements performed by the data collector.

20. The data aggregator of claim 15, wherein the series of measurements are obtained using a sensor that measures a characteristic of an ambient environment.
